(19) United States
(12) Patent Application Publication
(10) Pub. No.: US 2016/0080858 A1
(43) Pub. Date: Mar. 17, 2016

(54) HELMHOLTZ RESONATOR LOUDSPEAKER

(71) Applicant: Paul Wilke, The Hague (NL)

(72) Inventor: Paul Wilke, The Hague (NL)

(21) Appl. No.: 14/485,795

(22) Filed: Sep. 15, 2014

(51) Int. Cl. H04R 1/28

(52) U.S. Cl. CPC H04R 1/2807

(57) ABSTRACT

A Helmholz resonator loudspeaker having a capsule shape with substantial improvements over the existing art, including an improved way of mounting a driver on a tubular section, by having a gradual and continuous curved surface to connect the front of the driver to the tubular section without abrupt changes in geometry, thus creating an inverted horn; an improved way of mounting a resonator tube through one or both of the capsule ends to allow for optimum placement and reduction of curvature in the resonator tube; and ways to make a physical connection between two bass drivers mounted on opposing longitudinal sides of a tubular section in order to cancel out reaction forces.

### CROSS REFERENCE TO RELATED APPLICATIONS

This application claims the benefit of Provisional U.S. Patent Application No. 61/896,586, filed Oct. 28, 2013, the entirety of which is incorporated herein by reference.

### BACKGROUND

1. Field of the Invention

The present invention is generally directed to loudspeakers of the Helmholz resonator type. More specifically, the present invention embodies a number of improvements on a very efficient Helmholz resonator having a state of the art capsule shape, in order to minimize refraction and diffraction, maximize bass reproduction and minimize loudspeaker resonances caused by reaction forces.

2. Background of the Prior Art

This invention introduces improvements over the Helmholz resonator loudspeaker disclosed and claimed in U.S. Pat. No. 5,710,395. The generally capsule-shaped form that was therein disclosed introduced a number of advantages over more traditional loudspeaker enclosures in terms of bass reproduction, stereo imaging, internal reflections, weight and production costs. Shortly after the patent issued a loudspeaker model based on this invention was introduced in commerce and remains in production to this day. This model, the Harman SoundStick II, incorporates what is the state of the art in the field of loudspeakers made out of lightweight, relatively flexible materials. No other loudspeakers that contain the same or a similar generally capsule shaped form have entered the market since.

Development and use of the generally capsule-shaped loudspeaker has created a need for developing solutions to a number of problems inherent to that speaker design as described in the patent. These concerns fall generally in three areas.

The first problem to be addressed concerns the mounting of the drivers. In the original patent, the driver is mounted with the front of the driver being largely outside the tubular housing, with a second tubular component connecting the front of the driver to the tubular section of the speaker housing. In the existing commercial embodiment, the drivers are mounted inside the tubular housing, with a flange internal to the outside of the tubular housing connecting the tubular section of the housing to the driver. Both solutions are suboptimal. In the first configuration, the tubular component connecting the front of the driver with the tubular section of the housing has sharp transitions at both extremes. These sharp transitions cause measureable refraction and diffraction effects, noticeable as peaks and valleys in the measured frequency response. The second method of mounting the drivers as employed in the Harman SoundStick effectively creates a small baffle, which has detrimental effects on both the measured frequency response and on the loudspeakers' directivity. The solution to these problems is to have a gradual transition from the driver to the tubular section of the enclosure, so that the sound waves emanating from the driver do not get diffracted by sharp transitions or by baffle loading.

The second area of improvement concerns the placement of the resonator pipe. The embodiments as described in U.S. Pat. No. 5,710,395, one of which was employed in the SoundStick, have problems of an acoustic or practical nature. With the resonator pipe mounted from below and parallel to the tubular section of the enclosure, the practical aspect of the problem is that with a pipe thus mounted, it becomes impossible to place the loudspeakers directly on a hard surface, since this would close off the resonator pipe. The acoustic disadvantage of such an embodiment is that thus mounted, the resonator tube connection to the housing has its opening on the outside of the housing at a relatively long distance from the driver. Research has shown that bass reproduction is largest when the opening on the outside of the resonator tube is relatively close to the driver.

The second way of mounting the resonator pipe as shown in FIG. 3 of U.S. Pat. No. 5,710,395 is to mount the resonator pipe through the largely tubular section of the enclosure. The problem with this solution as also employed in the SoundStick, is that it requires the tubular section of the enclosure to be relatively long. Calculation and experimental means have established that this is not the optimum shape for this kind of loudspeaker, which generally requires the height of these loudspeaker to be less than three times their width. The solution found is to have the resonator pipe intersect one or both of the capsule ends at an angle. This ensures that the outside end of the resonator pipe can be placed close to the driver, while allowing at the same time optimal proportions for the enclosure.

The third area of improvement concerns the problem of reaction forces. When the cone of a loudspeaker driver is moved by the voice coil-magnet assembly, this creates reaction forces that have to be absorbed by the enclosure. In traditional loudspeakers, the typically heavy enclosure will provide the necessary heft to counteract and/or dampen these reaction forces, although there always remains a residual force. With the generally capsule shaped loudspeakers, large economies of production and cost can be achieved through the reduced weight of the enclosure. This however upsets the balance between the weight of the cone and the weight of the enclosure to the extent that, certainly with larger sized drivers, the movements caused by reaction forces become a genuine problem. The solution has been found by mounting two bass drivers on opposing longitudinal sides of the tubular section of the enclosure, with a physical connection between the two drivers. This can be achieved either by connecting the magnet assemblies or by connecting the baskets of the drivers. Thus, in either configuration the opposing reaction forces of the two drivers wired in phase cancel each other out, and at no time are these forces channeled through the enclosure, which avoids generating vibrations.

### BRIEF DESCRIPTION OF THE DRAWINGS

FIG. 1 is a perspective view of one embodiment of the Helmholtz resonator type loudspeaker in the prior art.

FIG. 2 is a top view of the prior art Helmholtz resonator type loudspeaker of FIG. 1.

FIG. 3 is a top view of an embodiment of an improved Helmholtz resonator type loudspeaker.

FIG. 4 is a perspective view of an embodiment of an improved Helmholtz resonator type loudspeaker.

FIG. 5 is a side view of an embodiment of an improved Helmholtz resonator type loudspeaker.

FIG. 6 is a side view of a second embodiment of an improved Helmholtz resonator type loudspeaker.

FIG. 7 is a horizontal cross-section view of an embodiment of an improved Helmholtz resonator type loudspeaker.

FIG. 8 is a horizontal cross-section view of a second embodiment of an improved Helmholtz resonator type loudspeaker.

FIG. 9 is a perspective view of an embodiment combining features of the improved Helmholtz resonator type loudspeaker shown in FIGS. 3-8.

### DETAILED DESCRIPTION OF THE INVENTION

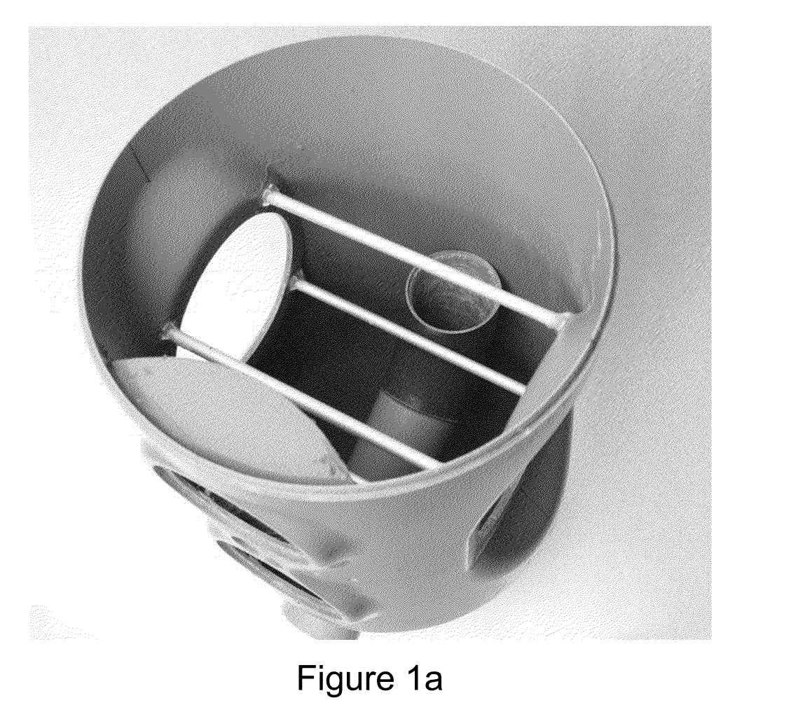

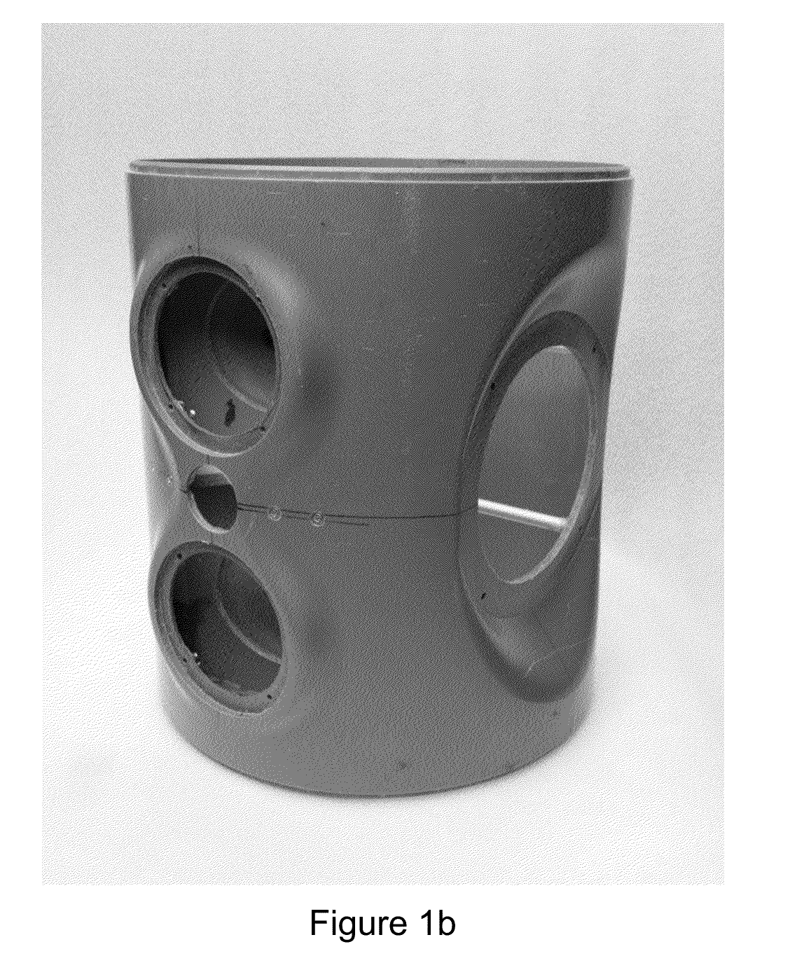

FIG. 1 shows a perspective view of one embodiment in the prior art, where loudspeaker driver 1 is mounted on a tubular main enclosure 2 by means of a tubular component section 3.

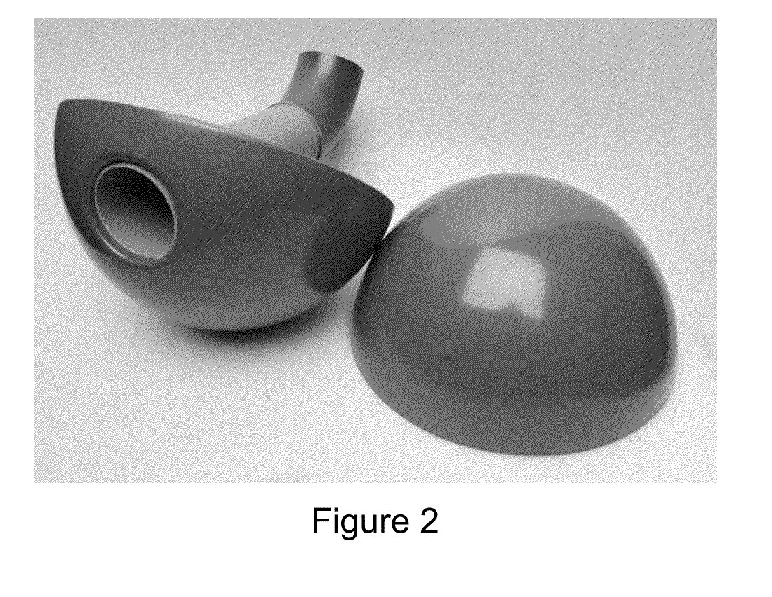

FIG. 2 shows a top view of the prior art loudspeaker depicted in FIG. 1, with driver 1 attached to a tubular component section 3, intersecting with the tubular main enclosure 2 at opening 5. It can be seen that in two instances there are sharp transitions: first along the rim 8 of driver 1, and second where the tubular component section 3 attaches to the main enclosure body at opening 5.

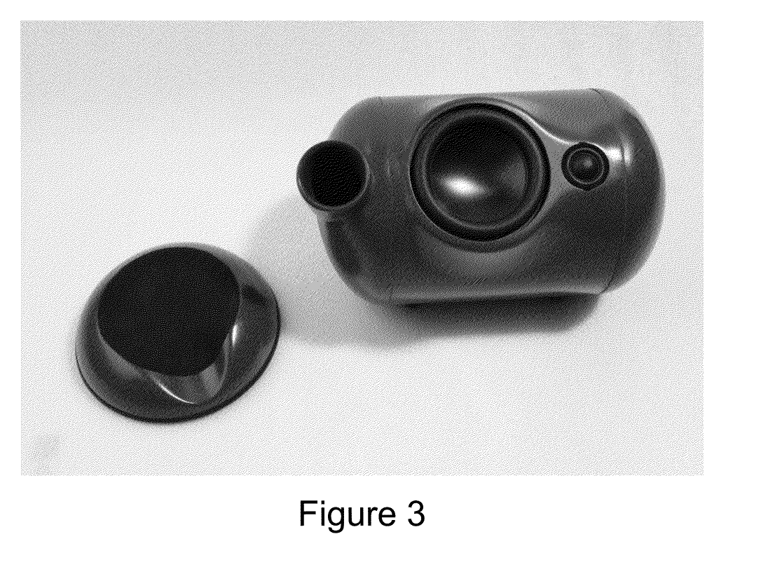

FIG. 3 shows a top view of an improved way of attaching driver 1 to tubular main enclosure 2 by means of a round flange 6 that is defined by two curvatures. The first curvature is where driver 1 attaches to the flange 6 at outer circumference 7, where the edge of flange 6 curves from the vertical plane of driver 1 towards the tubular main body 2 in a gradual way, distinguished from the sharp corner shown in FIG. 2 at rim 8. The second curvature is where the flange 6 attaches to the tubular main enclosure 2. In the embodiment shown, the circumferential edge of flange 6 includes a gradual orientation towards the main tubular body shown as flange curvature 9 so that flange 6 gradually aligns with the tubular main enclosure 2.

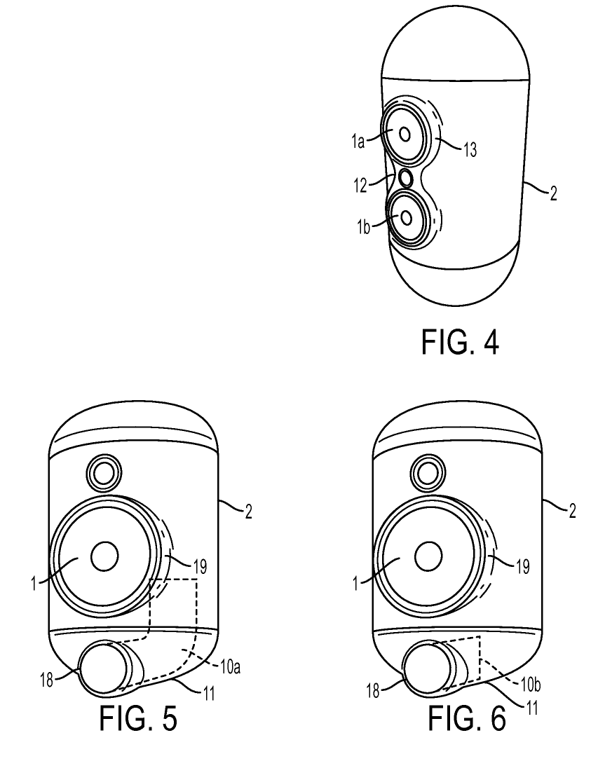

FIG. 4 shows an improved method of attaching two drivers 1a and 1b with a tweeter 12 in between drivers 1a and 1b. In the embodiment shown, drivers 1a and 1b with tweeter 12 in between are mounted to tubular main enclosure 2 via elongated flange 13. Because of the gradual curvature of the edges of elongated flange 13, which follows the contours of drivers 1a and 1b and tweeter 12, tweeter 12 protrudes slightly from the main tubular enclosure 2, thus maximizing horizontal dispersion of sound.

FIG. 5 shows a side view of an improved method of attaching a bass pipe 10 to a spherical end cap 11 of tubular main enclosure 2. Bass pipe 10a intersects with end cap 11 so that the plane of bass pipe external opening 18 aligns with the vertical plane in which driver 1 is mounted. Bass pipe 10a curves upwards internal of tubular main enclosure 2. Driver 1 is attached by means of a gradually-curving flange 19 to tubular main enclosure 2.

FIG. 6 shows a second embodiment of the improved method of attaching a bass pipe, where bass pipe 10b is straight. Similar to bass pipe 10a depicted in FIG. 5, bass pipe 10b intersects with end cap 11 so that the plane of bass pipe external opening 18 aligns with the vertical plane in which driver 1 is mounted. Driver 1 is attached by means of a gradually-curving flange 19 to tubular main enclosure 2.

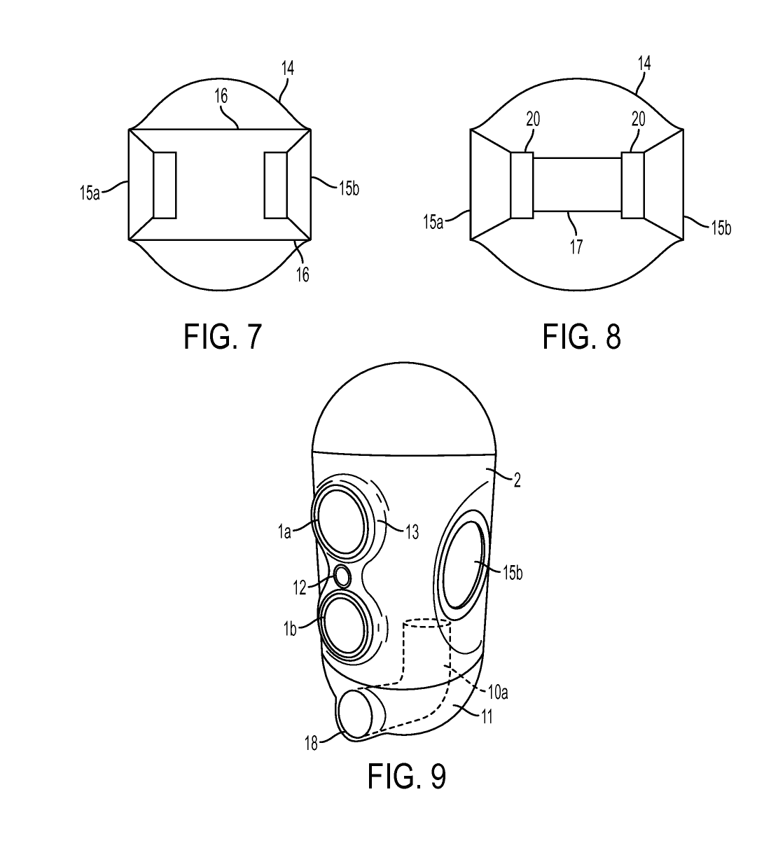

FIG. 7 shows a horizontal cross-section view of a tubular main enclosure 14 in which two drivers 15a and 15b are mounted at opposite surfaces of the tubular main enclosure 14. Both drivers 15a and 15b are connected through a plurality of connecting rods 16 along the basket of drivers 15a and 15b, so that reaction forces created by drivers 15a and 15b are mutually cancelling.

FIG. 8 shows a top view of a second embodiment of the speaker depicted in FIG. 7. In FIG. 8, the two drivers 15a and 15b are mounted at opposite surfaces of the tubular main enclosure 14. In this embodiment, both drivers 15a and 15b are connected through a single connecting rod 17, which is attached to the magnet assembly 20 of both drivers 15a and 15b.

FIG. 9 shows a perspective view of an embodiment combining the features detailed in FIGS. 3-8. In FIG. 9, bass pipe 10 intersects lower spherical end cap 11 so that the plane of bass pipe external opening 18 aligns with the vertical plane in which drivers 1a and 1b and tweeter 12 are mounted. Flange 13 shows a gradual curvature from driver rims to the tubular enclosure section 2. Driver 15b is connected internally to an identical driver 15a on the other side of tubular enclosure, which hides its view in this perspective drawing.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiments, methods, and examples, but by all embodiments and methods within the scope and spirit of the invention as claimed.

Even though particular combinations of features are recited in the claims and/or disclosed in the specification, these combinations are not intended to limit the disclosure of the invention. In fact, many of these features may be combined in ways not specifically recited in the claims and/or disclosed in the specification. Although each dependent claim listed below may directly depend on only one other claim, the disclosure of the invention includes each dependent claim in combination with every other claim in the claim set.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

I claim:

1. A Helmholtz resonator speaker, comprising:
a speaker assembly;
a speaker enclosure having a generally tubular shape with a hemispherical closure at each end of the tubular speaker enclosure so that the speaker enclosure forms a generally capsule shape;
a first opening in said speaker enclosure, said first opening adapted to receive said speaker assembly so that the axis of the speaker assembly forms a generally right angle to the axis of the speaker enclosure; and
a flange connecting said speaker enclosure and said speaker assembly so that the border between said speaker enclose and said speaker assembly comprises a smooth curve.

2. The Helmholtz resonator speaker of claim 1, further comprising:
a second opening in said speaker enclosure; and
a tube member disposed within said speaker housing, said tube member having a first tube end and a second tube end, wherein said first tube end is disposed in said speaker enclosure and said second tube end is connected to said speaker enclosure at said second opening so that when the speaker assembly generates sound waves within said speaker enclosure, the sound waves can enter into said first opening, propagate through said tube member, exit said second port, and exit said speaker enclosure.

3. The Helmholtz resonator speaker of claim 2, wherein said tube member is straight over its entire length.

4. The Helmholtz resonator speaker of claim 2, wherein said tube member is curved.

5. A Helmholtz resonator speaker, comprising:
a speaker assembly;
a speaker enclosure having a generally tubular shape with a hemispherical closure at each end of the tubular speaker enclosure so that the speaker enclosure forms a generally capsule shape;
a first opening in said speaker enclosure, said first opening adapted to receive said speaker assembly so that the axis of the speaker assembly forms a generally right angle to the axis of the speaker enclosure;
a second opening in said speaker enclosure, where said first opening and said second opening occupy the same plane.

6. A Helmholtz resonator speaker, comprising:
a speaker assembly;
a speaker enclosure having a generally tubular shape with a hemispherical closure at each end of the tubular speaker enclosure so that the speaker enclosure forms a generally capsule shape;
a first opening in said speaker enclosure, said first opening adapted to receive said speaker assembly so that the axis of the speaker assembly forms a generally right angle to the axis of the speaker enclosure;
a second opening in said speaker enclosure, where said first opening and said second opening occupy the same plane; and
a tube member disposed within said speaker housing, said tube member having a first tube end and a second tube end, wherein said first tube end is disposed in said speaker enclosure and said second tube end is connected to said speaker enclosure as said second opening, and where said tube intersects one of said hemispherical closures.

7. A Helmholtz resonator speaker, comprising:
a first speaker assembly;
a second speaker assembly;
a speaker enclosure having a generally tubular shape with a hemispherical closure at each end of the tubular speaker enclosure so that the speaker enclosure forms a generally capsule shape;
a first opening in said speaker enclosure, said first opening adapted to receive said first speaker assembly so that the axis of the first speaker assembly forms a generally right angle to the axis of the speaker enclosure;
a second opening in said speaker enclosure, where said first opening and said second opening are diametrically opposed to each other in the tubular speaker enclosure; and
a support member in direct physical connection between said first speaker assembly and said second speaker assembly.

8. The Helmholtz resonator speaker of claim 7, wherein said support member comprises a plurality of support members.
